(19) United States
(12) Patent Application Publication
(10) Pub. No.: US 2002/0147933 A1
(43) Pub. Date: Oct. 10, 2002

(54) Controlling method and system of a computer peripheral device with power-saving effect

(76) Inventors: Yi-Chang Chen, Taipei (TW); Chiao-Fang Chen, Taipei (TW)

Correspondence Address: NAIPO (NORTH AMERICA INTERNATIONAL PATENT OFFICE), P.O. BOX 506, MERRIFIELD, VA, 22116, US

(21) Appl. No.: 09/682,485

(22) Filed: Sep. 7, 2001

(30) Foreign Application Priority Data
Apr. 6, 2001 (TW) 090108358

(51) Int. Cl. G06F 1/26; G06F 1/32

(52) U.S. Cl. 713/320

(57) ABSTRACT

A computer system has a peripheral device, a plurality of internal components, system circuitry connected to the plurality of internal components via at least one bus, and connected to the peripheral device via a peripheral bus, and control circuitry for controlling power supplied to the system circuitry and the peripheral device. When the system circuitry and the peripheral device are at an off status, if the control circuitry receives a turn on instruction inputted to the peripheral device, the control circuitry turns on the peripheral device. When the control circuitry receives an operation instruction inputted to the peripheral device, the control circuitry turns on the system circuitry, so that the system circuitry is capable of controlling the peripheral device via the peripheral bus to execute the operation instruction. After executing the operation instruction, the system circuitry is turned off to save power.

### BACKGROUND OF INVENTION

1. Field of the Invention

The present invention relates to a controlling method and system of a computer peripheral device, and more particularly, a controlling method and system of a computer peripheral device with a power-saving effect that can help users to start a peripheral device without necessarily starting and warming up a whole computer system, so as to save power and cost.

2. Description of the Prior Art

Accompanying development and growing popularity of computer systems, functions of the computer system become more and more complex. A user spends a long period of time when starting and warming up a whole computer system, even if the useronly needs to use a simple function of a peripheral device, such as a CD drive to play music. A prior art device alleviates this problem.

According to the prior art, a single chip is installed among a system having a CPU, a CD drive, and related circuitry, so that users can instruct a CD drive to play music without necessarily starting and warming up the whole computer system. On the other hand, because of the necessity of adding the single chip, a cost is increased.

### SUMMARY OF INVENTION

It is therefore a primary objective of the present invention to provide a controlling method and system of a computer peripheral device with a power-saving effect, to solve the above mentioned problem. The present invention can help users to start a peripheral device without necessarily starting and warming up the whole computer system, and also without the necessity of adding a single chip, so as to save power and cost.

A control method for a peripheral device of a computer system is provided, according to the claimed invention. The computer system comprises system circuitry, a plurality of internal components and control circuitry. The system circuitry is connected with the plurality of internal components, for controlling operations of the internal components, via at least one bus. The peripheral device is electrically connected with the system circuitry via a peripheral bus. The control circuitry controls power supplied to the system circuitry and the peripheral device. When the system circuitry and the peripheral device are in an off state, the peripheral device is capable of performing peripheral functions after it is turned on. When the control circuitry receives an instruction inputted to the peripheral device to turn on the peripheral device, the control circuitry turns on the peripheral device, so that the peripheral device is capable of performing the peripheral functions. And, when the control circuitry receives an operation instruction inputted to the peripheral device, the control circuitry turns on the system circuitry, so that the system circuitry is capable of controlling the peripheral device via the peripheral bus to execute the operation instruction. After executing the operation instruction, the system circuitry is turned off so as to save power.

Briefly, a computer system according to the claimed invention comprises a peripheral device for performing a peripheral function for a user, a plurality of internal components, system circuitry connected to the plurality of internal components, via at least one bus, to control operations of each internal component, and connected with the peripheral device via a peripheral bus, and control circuitry for controlling power supplied to the system circuitry and the peripheral device. The peripheral device is capable of performing peripheral functions when it is turned on. When the system circuitry and the peripheral device are in an off state, if the control circuitry receives an instruction to turn on that was inputted to the peripheral device, the control circuitry turns on the peripheral device, so that the peripheral device is capable of performing the peripheral functions. When the control circuitry receives an operation instruction inputted to the peripheral device, the control circuitry turns on the system circuitry so that the system circuitry is capable of controlling the peripheral device via the peripheral bus to execute the operation instruction. After executing the operation instruction, the system circuitry is turned off to save power.

These and other objectives of the present invention will no doubt become obvious to those of ordinary skill in the art after reading the following detailed description of the preferred embodiment, which is illustrated in the various figures and drawings.

### BRIEF DESCRIPTION OF DRAWINGS

FIG. 1 is an internal operation block diagram of a computer system according to the present invention.

FIG. 2 is a perspective view of the computer system shown in FIG. 1.

FIG. 3 is a flow chart for operations of the computer system shown in FIG. 1.

### DETAILED DESCRIPTION

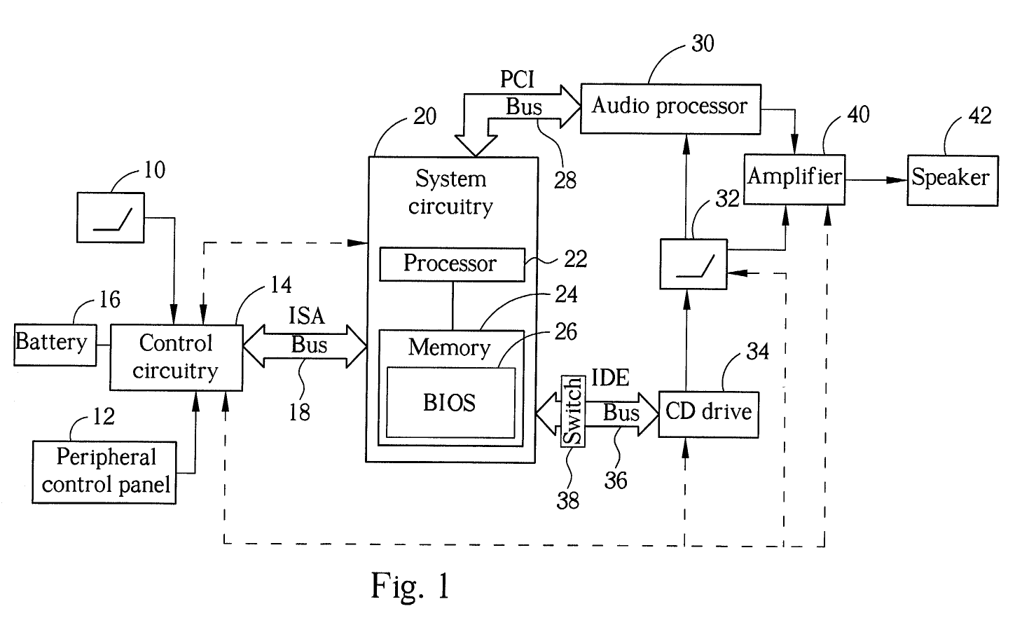

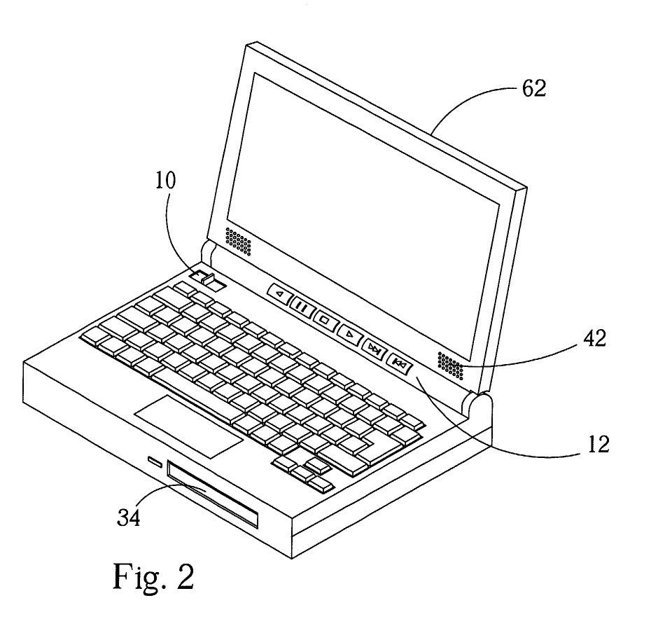

Please refer to FIG. 1 and FIG. 2. FIG. 1 is an internal operation block diagram of a computer system according to the present invention. FIG. 2 is a perspective view of the computer system shown in FIG. 1. A notebook 62 is used as an example. The notebook 62 comprises a peripheral device, a plurality of internal elements, system circuitry 20 and control circuitry 14. The peripheral device comprises a CD drive 34, an amplifier 40, and a speaker 42 for allowing a user to play an audio CD. The system circuitry 20 connects a plurality of internal elements via buses 18, 28, 36, wherein, the bus 36 is used to electrically connect to the peripheral device. The control circuitry 14 is used to control the system circuitry 20 and the power supplied to the CD drive 34. When the power of the peripheral device is turned on, the peripheral device can provide a user the corresponding peripheral function, such as playing the audio CD.

When the system circuitry 20 and the peripheral device are in an off state, if the control circuitry 1 4 receives an on instruction inputted to the peripheral device, the control circuitry 14 turns on the peripheral device, so that the peripheral device is capable of performing the peripheral functions, such as playing the audio CD. When the control circuitry 14 receives an operation instruction inputted to the peripheral device, the control circuitry 14 turns on the system circuitry 20, so that the system circuitry 20 is capable of controlling the peripheral device, via the peripheral bus 36, to execute the operation instruction. After executing the operation instruction, the system circuitry 20 is turned off to save power.

Referring to FIG. 1, the peripheral device further comprises an audio processor 30 and a path selector 32. The audio processor 30 is electrically connected between the CD drive 34 and the amplifier 40 for processing audio signals outputted by the CD drive 34. The system circuitry 20 is electrically connected with the audio processor 30 via the system bus 28 for controlling process functions of the audio processor 30. The path selector 32 is used to select whether to transmit the audio signals outputted from the CD drive 34 to the audio processor 30, or to the amplifier 40. When the control circuitry 14 receives an instruction to turn on the peripheral device, the control circuitry 14 turns on the CD drive 34, the amplifier 40 and the path selector 32. And, the control circuitry 14 controls the path selector 32 so as to transmit the audio signals outputted from the CD drive 34 to the amplifier 40.

The computer system 62 further comprises a battery 16 electrically connected to the control circuitry 14. The control circuitry 14 is turned on to maintain minimum operations of the computer system 62 as long as the battery supplies sufficient power to the control circuitry 14.

Please refer to FIG. 1 and FIG. 2. The computer system 62 further comprises a peripheral control panel 12 electrically connected to the control circuitry 14. The peripheral control panel 12 has an “on” key and a plurality of operation keys such as a “play” key, a “pause” key, a “stop” key, an “eject” key, a “forward” key and a “backward” key. Triggering the “on” key to generate the on instruction, the control circuitry 14 turns on the peripheral device. Triggering an operation key to generate an operation instruction, the control circuitry 14 turns on the system circuitry 20, so that the system circuitry 20 is capable of controlling the peripheral device via the peripheral bus 36 to execute the operation instruction. Moreover, a switch 38 is installed on the peripheral bus 36 for preventing the current supplied by the battery 16 to the CD drive 34 from flowing back to the system circuitry 20.

As shown in FIG. 1, the system circuitry 20 comprises a processor 22, a memory 24 and a BIOS (Basic Input Output System) 26 stored in the memory 24. After the control circuitry 14 turns on the system circuitry 20, the processor 22 executes the BIOS 26, and the BIOS 26 detects if the “on” key or any of the operation keys has been triggered. If one of the keys has been triggered, the system circuitry 20 controls the peripheral device via the peripheral bus 36 so as to execute the instruction. After executing the operation instruction, the system circuitry 20 is turned off by the control circuitry 14 so as to save power.

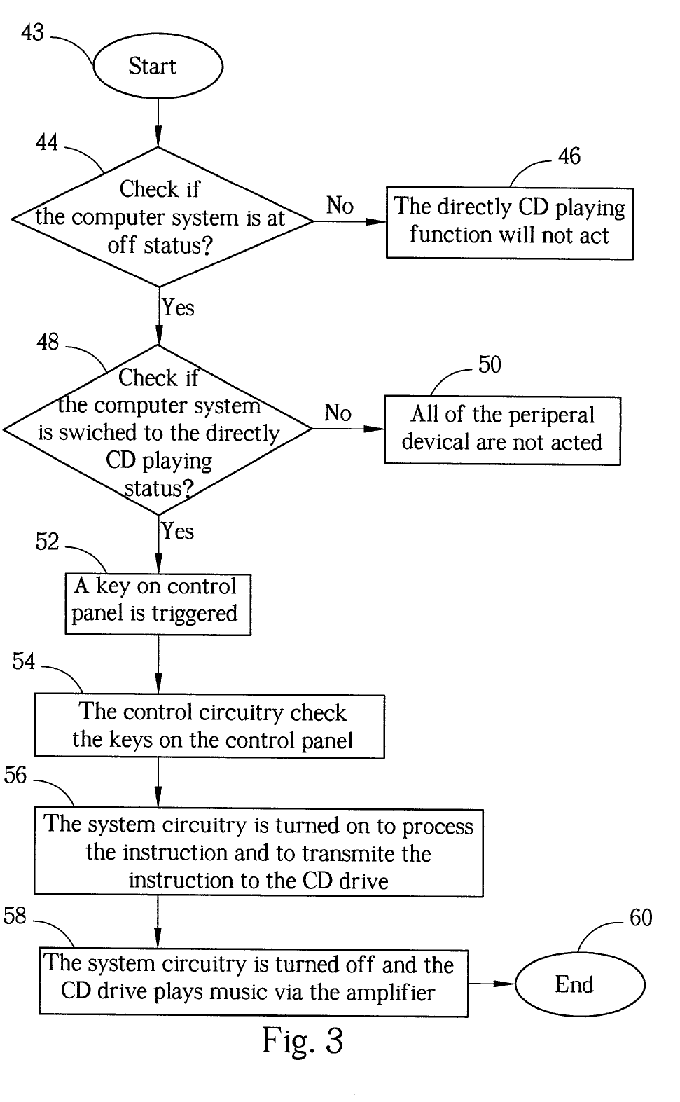

Please refer to FIG. 3. FIG. 3 is a flow chart for operations of the computer system 62 shown in FIG. 1. Operation of the computer system 62 comprises the following steps:Step 44: Check if the computer system 62 is at an off status. If not, go to step 46, else go to step 48.

Step 46: The computer system 62 must be at a normal on status, so the CD direct playing function according to the present invention does not activate.

Step 48: Check if the switch 10 of the computer 62 is switched to the CD direct playing status. If not, go to step 50, else go to step 52.

Step 50: The computer system 62 must be at a normal off status and no peripheral device is activated.

Step 52: Check if any key on the peripheral control panel 12 has been triggered.

Step 54: The control circuitry 14 checks the triggering status of the keys 54 to see which of the keys was triggered.

Step 56: Once the key that was triggered is checked, the control circuitry 14 turns on the system circuitry 20 to process the instruction according to the triggered key and to transmit the instruction to the CD drive 34 via the peripheral bus 36.

Step 58: After the instruction has been executed by the system circuitry 20, the control circuitry 14 turns off the system circuitry 20. The instruction transmitted to the CD drive 34 is transmitted to the amplifier 40 via the path selector 32, and is further transmitted to the speaker 58 for playing the audio CD.

In contrast to the prior art, the controlling method and system of a computer peripheral device with the power-saving effect according to the present invention is able to directly play a CD from a CD drive 34 without turning on and warming up the whole computer system 62, so as to save power. Moreover, the present invention is able directly to play a CD from a CD drive 34 by the system circuitry 20 of the computer system 62 without the necessity of adding the single chip according to the prior art, so as to reduce cost.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A control method for a peripheral device of a computer system, the computer system comprising system circuitry, a plurality of internal components and control circuitry, the system circuitry being connected with the plurality of internal components for operations of the internal components via at least one bus, the peripheral device being electrically connected with the system circuitry via a peripheral bus, the control circuitry controlling power supplied to the system circuitry and the peripheral device, the peripheral device being capable of performing peripheral functions when turned on, wherein when the system circuitry and the peripheral device are at an off status, the control method comprises:
when the control circuitry receives an on instruction inputted to the peripheral device to turn on the peripheral device, the control circuitry will turn on the peripheral device so that the peripheral device is capable of performing the peripheral functions; and when the control circuitry receives an operation instruction inputted to the peripheral device, the control circuitry will turn on the system circuitry so that the system circuitry is capable of controlling the peripheral device via the peripheral bus to execute the operation instruction, the system circuitry being turned off after executing the operation instruction to save power.

2. The control method of claim 1 wherein the peripheral device comprises a CD drive, an amplifier and a speaker for performing broadcasting functions.

3. The control method of claim 2 wherein the peripheral device further comprises an audio processor and a path selector, the audio processor being electrically connected between the CD drive and the amplifier for processing audio signals outputted by the CD drive, the system circuitry being electrically connected with the audio processor via a system bus for controlling process functions of the audio processor, the path selector being used to select transmitting the audio signals outputted from the CD drive to the audio processor or to the amplifier wherein when receiving an instruction to turn on the peripheral device, the control circuitry will turn on the CD drive, the amplifier and the path selector and will control the path selector so as to transmit the audio signals outputted from the CD drive to the amplifier.

4. The control method of claim 1 wherein the computer system further comprises a battery electrically connected to the control circuitry; and the control circuitry is turned on to maintain minimum operations of the computer system as long as the battery supplies sufficient power to the control circuitry.

5. The control method of claim 1 wherein the computer system further comprises a peripheral control panel electrically connected to the control circuitry, the peripheral control panel having an on key and a plurality of operation keys; wherein when the triggering the on key to generate the on instruction, the control circuitry will turn on the peripheral device; and when triggering an operation key to generate an operation instruction, the control circuitry will turn on the system circuitry so that the system circuitry is capable of controlling the peripheral device via the peripheral bus to execute the operation instruction.

6. The control method of claim 5 wherein the system circuitry comprises a processor, a memory and a BIOS (basic input output system) stored in the memory; after the control circuitry turns on the system circuitry, the processor will execute the BIOS, and the BIOS will detect if any of the on key and the operation keys has been triggered; and if so, the system circuitry will control the peripheral device via the peripheral bus so as to execute the instruction.

7. The control method of claim 6 wherein after executing the instruction, the system circuitry will inform the control circuitry to turn off the system circuitry so as to save power.

8. A computer system comprising:
a peripheral device for performing a peripheral function for a user;
a plurality of internal components;
system circuitry connected to the plurality of internal components via at least one bus to control operations of each internal component, the system circuitry being electrically connected with the peripheral device via a peripheral bus; and
control circuitry for controlling power supplied to the system circuitry and the peripheral device, the peripheral device is capable of performing peripheral functions when turned on;
wherein when the system circuitry and the peripheral device are at an off status, if the control circuitry receives an on instruction inputted to the peripheral device, the control circuitry will turn on the peripheral device so that the peripheral device is capable of performing the peripheral functions; and when the control circuitry receives an operation instruction inputted to the peripheral device, the control circuitry will turn on the system circuitry so that the system circuitry is capable of controlling the peripheral device via the peripheral bus to execute the operation instruction, the system circuitry being turned off after executing the operation instruction to save power.

9. The computer system of claim 8 wherein the peripheral device comprises a CD drive, an amplifier and a speaker for performing broadcasting functions.

10. The computer system of claim 9 wherein the peripheral device further comprises an audio processor and a path selector, the audio processor being electrically connected between the CD drive and the amplifier for processing audio signals outputted by the CD drive, the system circuitry being electrically connected with the audio processor via a system bus for controlling process functions of the audio processor, the path selector being used to select transmitting the audio signals outputted from the CD drive to the audio processor or to the amplifier wherein when receiving an instruction to turn on the peripheral device, the control circuitry will turn on the CD drive, the amplifier and the path selector and will control the path selector so as to transmit the audio signals outputted from the CD drive to the amplifier.

11. The computer system of claim 8 wherein the computer system further comprises a battery electrically connected to the control circuitry; and the control circuitry is turned on to maintain minimum operations of the computer system as long as the battery supplies sufficient power to the control circuitry.

12. The computer system of claim 8 wherein the computer system further comprises a peripheral control panel electrically connected to the control circuitry, the peripheral control panel having an on key and a plurality of operation keys; wherein when the triggering the on key to generate the on instruction, the control circuitry will turn on the peripheral device; and when triggering an operation key to generate an operation instruction, the control circuitry will turn on the system circuitry so that the system circuitry is capable of controlling the peripheral device via the peripheral bus to execute the operation instruction.

13. The computer system of claim 12 wherein the system circuitry comprises a processor, a memory and a BIOS (basic input output system) stored in the memory; after the control circuitry turns on the system circuitry, the processor will execute the BIOS, and the BIOS will detect if any of the on key and the operation keys has been triggered; and if so, the system circuitry will control the peripheral device via the peripheral bus so as to execute the instruction.

14. The computer system of claim 13 wherein after executing the instruction, the system circuitry will inform the control circuitry to turn off the system circuitry so as to save power.
